(19) United States
(12) Patent Application Publication
(10) Pub. No.: US 2002/0086734 A1
(43) Pub. Date: Jul. 4, 2002

(54) Set-top box storage of games for games for game console

(76) Inventors: Aditya Krishnan, San Diego, CA (US); Matthew S. Chang, San Diego, CA (US); Andrew M. Proehl, San Francisco, CA (US); David K.L. Yang, San Jose, CA (US); Fred J. Zustak, Poway, CA (US); Peter Rae Shintani, San Diego, CA (US); Mark Kenneth Eyer, San Diego, CA (US); Nicholas Colsey, Del Mar, CA (US); Brant L. Candelore, Escondido, CA (US); Dayan Ivy Golden, San Diego, CA (US)

Correspondence Address: MILLER PATENT SERVICES, 2500 DOCKERY LANE, RALEIGH, NC, 27606, US

(21) Appl. No.: 09/753,404

(22) Filed: Jan. 3, 2001

(51) Int. Cl. G06F 17/00

(52) U.S. Cl. 463/43

(57) ABSTRACT

An Electronic Game Console is connected to a television set-top box. The set-top box can access a game server or other game controllers via the Internet to download game software to a mass storage device residing in or associated with the set-top box. The Electronic Game Console can then access the set-top box mass storage to run the game software.

### FIELD OF THE INVENTION

This invention relates generally to the field of electronic games. More particularly, this invention relates to a method and apparatus wherein game software can be downloaded to a television set-top box and accessed by an attached game console.

### BACKGROUND OF THE INVENTION

Electronic game consoles made by various manufacturers generally include either a cartridge, Compact Disc (CD) or Digital Versatile Disc (DVD) based game storage mechanism. In the past, such electronic game consoles were only able to run computer programs realizing electronic games if stored on such media. However, there is an increasing trend toward distribution of game software electronically via the Internet. This is a common mode of game distribution for personal computer-based games and would be a desirable game distribution mechanism for game console-based games.

Electronic game console manufacturers are heavily dependent upon revenue from the game software for profits, and often only break even or even lose money on the electronic game console itself. This is due to the perception the electronic game consoles have an upper price limit that consumers are willing to pay. Thus, there is a strong incentive to provide electronic game consoles at a minimum cost. The addition of mass storage and a modem for storing and downloading electronic games as a standard part of an electronic game console is thus likely to increase the manufacturing cost and selling price to an unacceptable level.

### SUMMARY OF THE INVENTION

The present invention relates generally to electronic games. Objects, advantages and features of the invention will become apparent to those skilled in the art upon consideration of the following detailed description of the invention.

In certain embodiments of the invention, an Electronic Game Console is connected to a television set-top box. The set-top box can access a game server or other game controllers via the Internet or a service provider or a direct modem connection to download game software to a mass storage device residing in or associated with the set-top box. The Electronic Game Console can then access the set-top box mass storage to run the game software.

In one embodiment of an electronic game console consistent with the present invention, a method of accessing an electronic game includes: determining that a set-top box having a mass storage device is connected to the electronic game console, the mass storage device storing software implementing the electronic game; and at the electronic game console, accessing the software stored on the mass storage device that implements the electronic game in order to run the electronic game on a central processor situated in the game console.

An electronic game console consistent with embodiments of the present invention includes a central processor. Memory is coupled to the central processor to store data and instructions. An interface is coupled to the central processor, in a manner suitable for connection to a television set-top box. A computer program resides in the memory, for accessing game software residing on the set-top box.

In another embodiment of the present invention, a television set-top box includes a central processor unit. Memory is coupled to the central processor unit. A mass storage device is also operatively coupled to the central processor unit. A modem is connected to the central processor unit in a manner suitable for connecting to the Internet. A computer program resides in the memory and permits downloading of a software program implementing an electronic game for storage to the mass storage device from the Internet via the modem. An interface suitable for connection to an electronic game console permits the game console to access the software program implementing the electronic game residing on the mass storage device.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a system block diagram of a system using a set-top box.

FIG. 2 is a functional block diagram of a digital set-top box suitable for use with the present invention.

FIG. 3 is a system block diagram illustrating a set-top box used in conjunction with a game console in an arrangement consistent with the present invention.

FIG. 4 is a flow chart illustrating a process consistent with embodiments of the present invention.

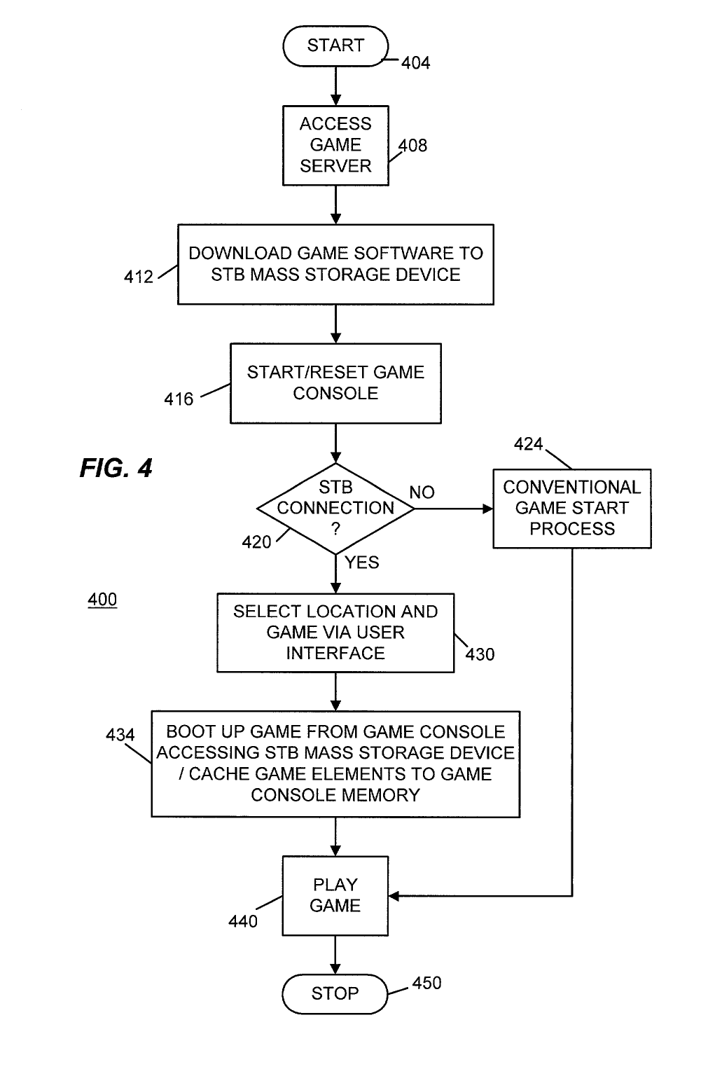

FIG. 5 is a system block diagram of a system of game controllers coupled together in various ways using a set-top box, modem connection or Internet connection.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

In accordance with certain embodiments of the present invention, mass storage of a television set-top box is utilized to provide for game storage accessable to an electronic game console. Thus the user can connect the electronic game console to the set-top box of his or her home entertainment system to download electronic games to the set-top box, store the games in the set-top box and access the games on the set-top box using the game console.

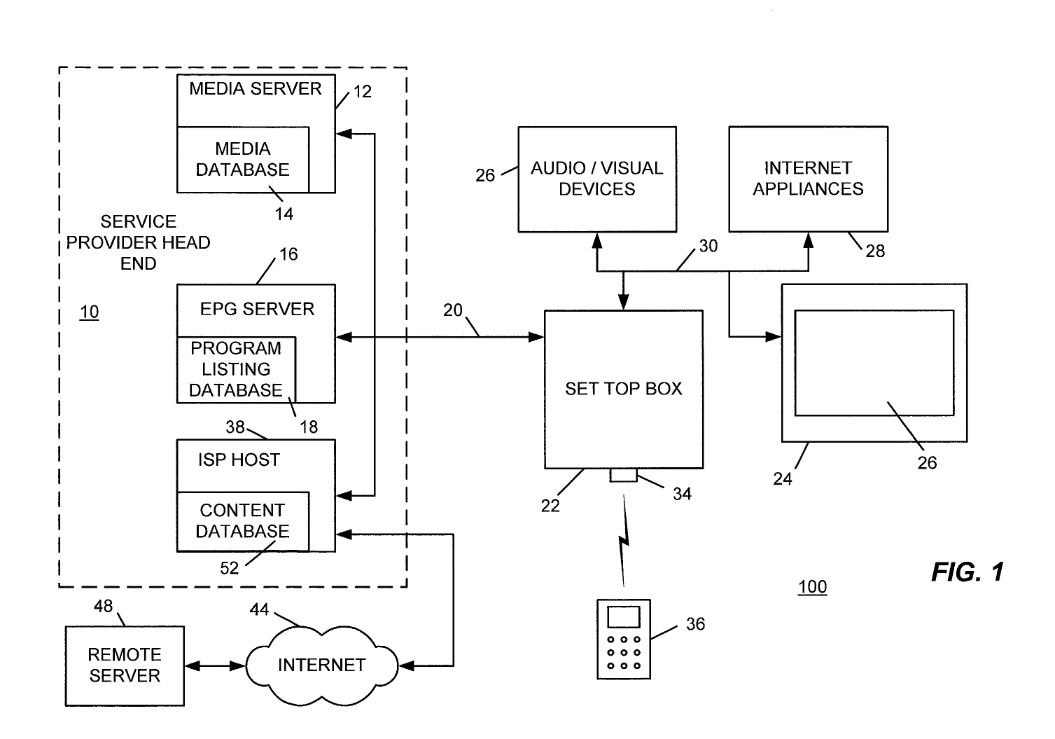

Referring to FIG. 1, a block diagram for an exemplary interactive cable or satellite television (TV) system 100 is shown. The system 100 includes, at a head end of the service provider 10, a media server 12 for providing, on demand, movies and other programming obtained from a media database 14. The media server 12 might also provide additional content such as interviews with the actors, games, advertisements, available merchandise, associated Web pages, interactive games and other related content. The system 100 also includes an electronic programming guide (EPG) server 16 and a program listing database 18 for generating an EPG. Set-top box 22 can generally provide for bidirectional communication over a transmission medium 20 in the case of a cable STB 22. In other embodiments, bidirectional communication can be effected using asymmetrical communication techniques possibly using dual communication media—one for the uplink and one for the downlink. In any event, the STB 22 can have its own Universal Resource Locator (URL) or IP address or other unique identifier assigned thereto to provide for addressability by the head end and users of the Internet.

The media server 12 and EPG server 16 are operatively coupled by transmission medium 20 to a set-top box (STB) 22. The transmission medium 20 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a cable television network, transmission medium 20 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB 22.

The exemplary system 100 further includes a TV 24, such as a digital television, having a display 26 for displaying programming, an EPG, etc. The STB 22 may be coupled to the TV 24 and various other audio/visual devices 26 (such as audio systems, Personal Video Recorders (PVRs), Video Tape Recorders (VTRs), Video Cassette Recorders (VCRs) and the like), storage devices (e.g., hard disc drives) and Internet Appliances 28 (such as email devices, home appliances, storage devices, network devices, and other Internet Enabled Appliances) by an appropriate interface 30, which can be any suitable analog or digital interface. In one embodiment, interface 30 conforms to an interface standard such as the Institute of Electrical and Electronics Engineers (IEEE) 1394 standard, but could also be wholly or partially supported by a DVI interface (Digital Visual Interface Digital—Display Working Group, www.ddwg.org) or other suitable interface.

The STB 22 may include a central processing unit (CPU) such as a microprocessor and memory such as Random Access Memory (RAM), Read Only Memory (ROM), flash memory, mass storage such as a hard disc drive, floppy disc drive, optical disc drive or may accommodate other electronic storage media, etc. Such memory and storage media is suitable for storing data as well as instructions for programmed processes for execution on the CPU, as will be discussed later. Information and programs stored on the electronic storage media or memory may also be transported over any suitable transmission medium such as that illustrated as 20. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 24 itself, thus eliminating the STB 22. Further, a computer having a tuner device and modem may be equivalently substituted for the TV 24 and STB 22.

By way of example, the STB 22 may be coupled to devices such as a personal computer, video cassette recorder, camcorder, digital camera, personal digital assistant and other audio/visual or Internet related devices. In addition, a data transport architecture, such as that set forth by an industry group which includes Sony Corporation and known as the Home Audio-Video Interoperability (HAVi) architecture may be utilized to enable interoperability among devices on a network regardless of the manufacturer of the device. This forms a home network system wherein electronic devices and Internet appliances are compatible with each other. The STB 22 runs an operating system suitable for a home network system such as Sony Corporation's Aperios™ real time operating system. Other operating systems could also be used.

The STB 22 includes an infrared (IR) receiver 34 for receiving IR signals from an input device such as remote control 36. Alternatively, it is noted that many other control communication methods may be utilized besides IR, such as wired or wireless radio frequency, etc. In addition, it can be readily appreciated that the input device 36 may be any device suitable for controlling the STB 22 such as a remote control, personal digital assistant, laptop computer, keyboard or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line) or the same transmission medium 20 described above (e.g., using a cable modem) to, thus, provide access to services and content from the ISP and the Internet. The ISP host 38 provides various content to the user that is obtained from a content database 42. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

While the arrangement illustrated in FIG. 1 shows a plurality of servers and databases depicted as independent devices, any one or more of the servers can operate as server software residing on a single computer. Moreover, although not explicitly illustrated, the servers may operate in a coordinated manner under centralized or distributed control to provide multiple services as a Multiple Service Operator (MSO) in a known manner. Additionally, the services provided by the servers shown in FIG. 1 may actually reside in other locations, but from the perspective of the user of STB 22, the service provider 10 serves as a portal to the services shown. Those skilled in the art will appreciate that the illustration of FIG. 1 represents a simplified depiction of a cable system configuration shown simply as service provider 10. The actual configuration of the service provider's equipment is more likely to follow a configuration defined by the CableLabs OpenCable™ specification. The simplified illustration shown is intended to simplify the discussion of the service provider 10's operation without unnecessarily burdening the discussion with architectural details that will be evident to those skilled in the art. Those details can be found in the publicly available CableLabs OpenCable™ specification or in the text “OpenCable Architecture (Fundamentals)” by Michael Adams, Cisco Press, Nov. 1999.

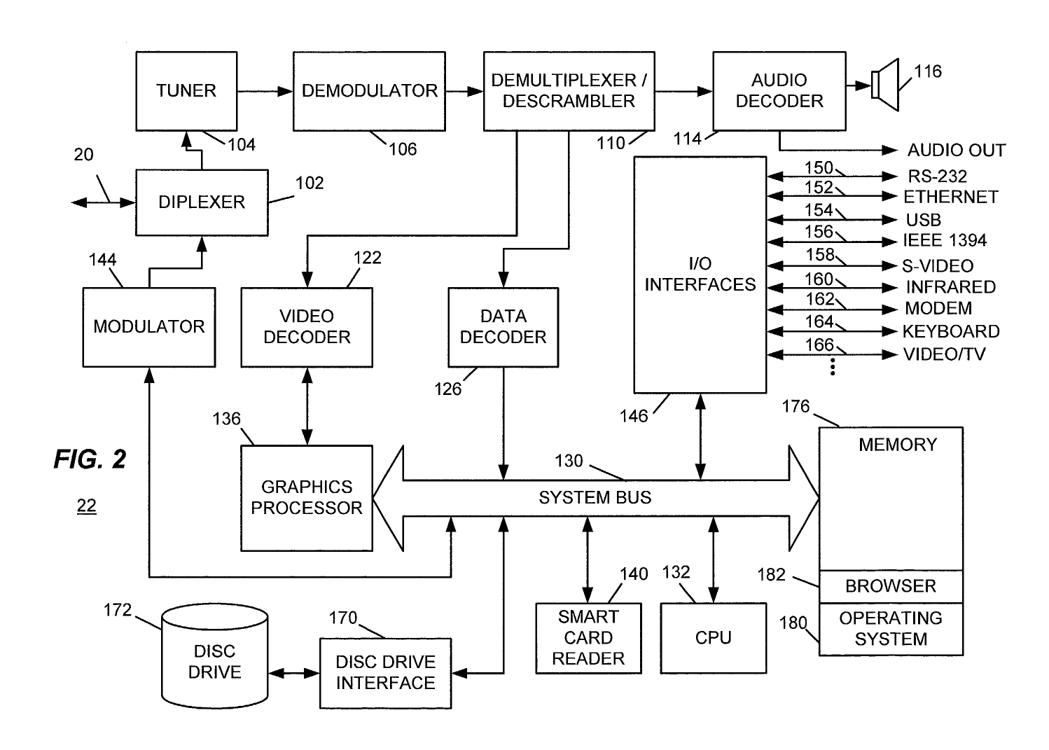

Referring now to FIG. 2, a typical system configuration for a digital set-top box 22 is illustrated. In this exemplary set-top box, the transmission medium 20, such as a coaxial cable, is coupled by a suitable interface through a diplexer 102 to a tuner 104. Tuner 104 may, for example, include a broadcast in-band tuner for receiving content, an out-of-band (OOB) tuner for receiving data transmissions. A return path through diplexer 102 provides an OOB return path for outbound data (destined for example for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g., audio, video, data). The demodulator and descrambler circuit 110 also decrypts encrypted information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g., stereo or home theater multiple channel audio systems) or other audio system 116 (e.g., stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder 126.

Decoded data packets from data decoder 126 are sent to the set-top box's computer system via the system bus 130. A central processing unit (CPU) 132 can thus access the decoded data from data decoder 126 via the system bus 130. Video data decoded by video decoder 122 is passed to a graphics processor 136, which is a computer optimized to processes graphics information rapidly. Graphics processor 136 is particularly useful in processing graphics intensive data associated with Internet browsing, gaming and multimedia applications such as those associated with MHEG (Multimedia and Hypermedia information coding Experts Group) set-top box applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 110 to a video encoder. Graphics processor 136 is also coupled to the system bus 130 and operates under the control of CPU 132.

Many set-top boxes such as STB 22 may incorporate a smart card reader 140 for communicating with a so called “smart card,” often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bidirectional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the diplexer 102 and out through the transmission medium 20. This capability is used to provide a mechanism for the STB 22 and/or its user to send information to the head end (e.g., service requests or changes, registration information, etc.) as well as to provide fast outbound communication with the Internet or other services provided at the head end to the end user.

Set-top box 22 may include any of a plurality of I/O (Input/Output) interfaces represented by I/O interfaces 146 that permit interconnection of I/O devices to the set-top box 22. By way of example, and not limitation, a serial RS-232 port 150 can be provided to enable interconnection to any suitable serial device supported by the STB 22's internal software. Similarly, communication with appropriately compatible devices can be provided via an Ethernet port 152, a USB (Universal Serial Bus) port 154, an IEEE 1394 (so-called firewire™ or i-link™ ) or IEEE 1394 wide port 156, S-video port 158 or infrared port 160. Such interfaces can be utilized to interconnect the STB 22 with any of a variety of accessory devices such as storage devices, audio/visual devices 26, gaming devices (not shown), Internet Appliances 28, etc.

I/O interfaces 146 can include a modem (be it dial-up, cable, DSL or other technology modem) having a modem port 162 to facilitate high speed or alternative access to the Internet or other data communication functions. In one preferred embodiment, modem port 162 is that of a DOCSIS (Data Over Cable System Interface Specification) cable modem to facilitate high speed network access over a cable system, and port 162 is appropriately coupled to the transmission medium 20 embodied as a coaxial cable. Thus, the STB 22 can carry out bidirectional communication via the DOCSIS cable modem with the STB 22 being identified by a unique IP address. The DOCSIS specification is publically available.

A PS/2 or other keyboard/mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 24 instead of (or in addition to) an IEEE 1394 connection such as that illustrated as 30. In one embodiment, Video output 166 can provide composite video formatted as NTSC (National Television System Committee) video. In some embodiments, the video output 166 can be provided by a direct connection to the graphics processor 136 or the demultiplexer/descrambler 110 rather than passing through the system bus 130 as illustrated in the exemplary block diagram. S-Video signals from output 158 can be similarly provided without passing through the system bus 130 if desired in other embodiments.

The infrared port 160 can be embodied as an infrared receiver 34 as illustrated in FIG. 1, to receive commands from an infrared remote control 36, infrared keyboard or other infrared control device. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired.

STB 22 will more commonly, as time goes on, include a disc drive interface 170 and disc drive mass storage 172 for user storage of content and data as well as providing storage of programs operating on CPU 132. STB 22 may also include floppy disc drives, CD ROM drives, CD R/W drives, DVD drives, etc. CPU 132, in order to operate as a computer, is coupled through the system bus 130 (or through a multiple bus architecture) to memory 176. Memory 178 may include a combination any suitable memory technology including Random Access Memory (RAM), Read Only Memory (ROM), Flash memory, Electrically Erasable Programmable Read Only Memory (EEPROM), etc.

While the above exemplary system including STB 22 is illustrative of the basic components of a digital set-top box suitable for use with the present invention, the architecture shown should not be considered limiting since many variations of the hardware configuration are possible without departing from the present invention. The present invention could, for example, also be implemented in more advanced architectures such as that disclosed in U.S. patent application Ser. No. 09/473,625, filed Dec. 29, 1999, Docket No. SONY-50N3508 entitled “Improved Internet Set-Top Box Having and In-Band Tuner and Cable Modem” to Jun Maruo and Atsushi Kagami. This application describes a set-top box using a multiple bus architecture with a high level of encryption between components for added security. This application is hereby incorporated by reference as though disclosed fully herein.

In general, during operation of the STB 22, an appropriate operating system180 such as, for example, Sony Corporation's Aperios™ real time operating system is loaded into, or is permanently stored in, active memory along with the appropriate drivers for communication with the various interfaces. In other embodiments, other operating systems such as Microsoft Corporation's Windows CE™ could be used without departing from the present invention. Along with the operating system and associated drivers, the STB 22 usually operates using browser software 182 in active memory or may permanently reside in ROM, EEPROM or Flash memory, for example. The browser software 182 typically operates as the mechanism for viewing not only web pages on the Internet, but also serves as the mechanism for viewing an Electronic Program Guide (EPG) formatted as an HTML document. The browser 182 can also provide the mechanism for viewing normal programming (wherein normal programming is viewed as an HTML video window—often occupying the entire area of screen 26).

STB software architectures vary depending upon the operating system. However, in general, all such architectures generally include, at the lowest layer, various hardware interface layers. Next is an operating system layer as previously described. The software architectures of modern STB have generally evolved to include a next layer referred to as “middleware.” Such middleware permits applications to run on multiple platforms with little regard for the actual operating system in place. Middleware standards are still evolving at this writing, but are commonly based upon Javascript and HTML (hypertext Markup Language) virtual machines. At the top layer is the application layer where user applications and the like reside (e.g., browsing, email, EPG, Video On Demand (VOD), rich multimedia applications, pay per view, etc.). The current invention can be utilized with any suitable set-top box software and hardware architecture.

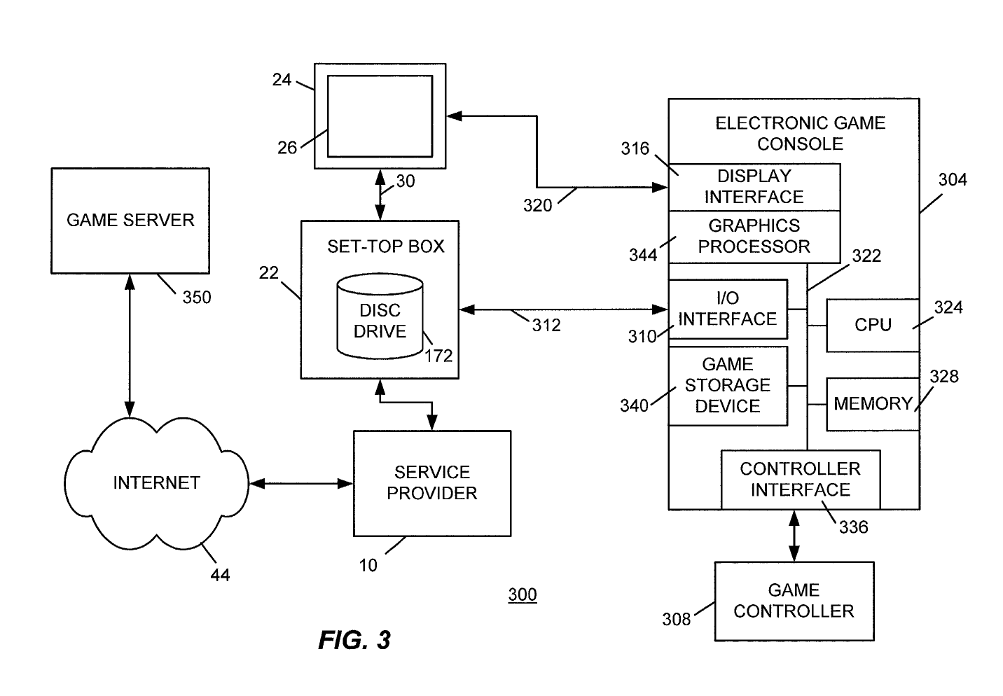

Referring now to FIG. 3, a system 300 is illustrated in which an electronic game console 304 is interfaced with STB 22 in a manner consistent with the present invention. Electronic Game Console 304 generally includes a game controller device 308 such as a game pad, joystick or the like for manipulating images appearing on display 26 of television 24 to either effect menu selections or manipulate game related objects. The Electronic Game Console 304 is connected to STB 22 via any suitable connection provided on or adapted to both the STB 22 and the Electronic Game Console 304. In the embodiment illustrated, an I/O interface (e.g., an IEEE 1394 or USB interface) 310 is connected by a suitable connection 312 to a compatible interface on the STB 22.

STB 22 is connected as previously described to television 26 via connection 30. In one embodiment, connection 30 is embodied as an IEEE 1394 connection and connection 312 may be the same IEEE 1394 connection. In other embodiments, the Electronic Game Console 304 is connected via an appropriate display interface 316 and connection 320 directly to an input of the television 26.

Electronic Game Console 304 generally includes a central processor 324 and memory 328 coupled together using a system bus 332. The game controller 308 is connected via an appropriate controller interface 336 to the central processor 324 through the system bus 332. A game storage device 340, such as a DVD player, CD player or game cartridge interface is also coupled to the system bus 332 for access by the central processor 324. A graphics processor 344 may be connected to the system bus 332 to effect high speed graphics generation for conversion to a video display format by the display interface 316. In some embodiments, as will be shown later, the game console 304 may also include an internal or externally connected modem (e.g., a dial up or other modem) that communicates with the CPU 324. Such modem can be used to directly connect to other game consoles or to the Internet through a service provider, as will be described later.

In operation, the user can access a web site residing on a game server 350 using either the Electronic Game Console 304 as a user interface or any other suitable user interface to download software embodying an electronic game to the disc drive 172, which may be a PVR (Personal Video Recorder) disc drive, coupled to STB 22. This can be accomplished using the browser software 182 residing on the STB 22 with or without the Electronic Game Console 304 being connected or running. The STB 22's browser 182, communicating through service provider 10 addresses a URL associated with the game server 350 and downloads software embodying the electronic game (possibly in compressed form) via the Internet 44 to disc drive 172 in a more or less conventional manner. Once the game is stored on the STB 22's disc drive 172, the software can be accessed and played by loading at least a portion of the game software to memory 328 and running the software on central processor 324. In this manner, games can be stored and played using existing software and hardware without the need to provide dedicated storage for the Electronic Game Console 304. Thus, in this manner the STB 22 serves as a file server for the Electronic Game Console 304.

This general process is described in somewhat greater detail in connection with FIG. 2 as process 400. The process starts at 404 and the STB 22 accesses the game server 350 by addressing its URL via the Internet 44 at 408. At 412, the selected game software is downloaded from the game server 350 and stored on the disc drive 172. At this point, the STB 22 can operate as a file server for the STB 22. At 416, the Electronic Game Console 304 can be reset, started or otherwise taken to an operational mode wherein a game can be selected. In one embodiment of the present invention, the Electronic Game Console 304 can determine if a STB is connected to the Electronic Game Console 304 at 420. If not, the Electronic Game Console 304 defaults to a conventional game start process at 424 by looking only to the game storage device 340 for a game or games stored as software therein.

However, if a STB 22 is connected to the Electronic Game Console 304 at 420, the user is presented with a menu of options via any suitable user interface at 430. The menu of options can comprise a display of game titles available via the game storage device 340 as well as storage locations (e.g., directories and subdirectories of disc drive 172) and/or titles of games stored on the disc drive 172. The user can then select a suitable game software program to execute at 430 from either the game storage device 340 or the disc drive 172. At 434, the selected game is booted at the Electronic Game Console 304 by loading and/or caching appropriate program elements from the disc drive 172 to active memory 328 of the Electronic Game Console 304. Normal game play is carried out at 440, whether the game comes from the conventional process of retrieval from storage device 340 at 424 or by booting from the disc drive 172 at 434 until the process is terminated at 450.

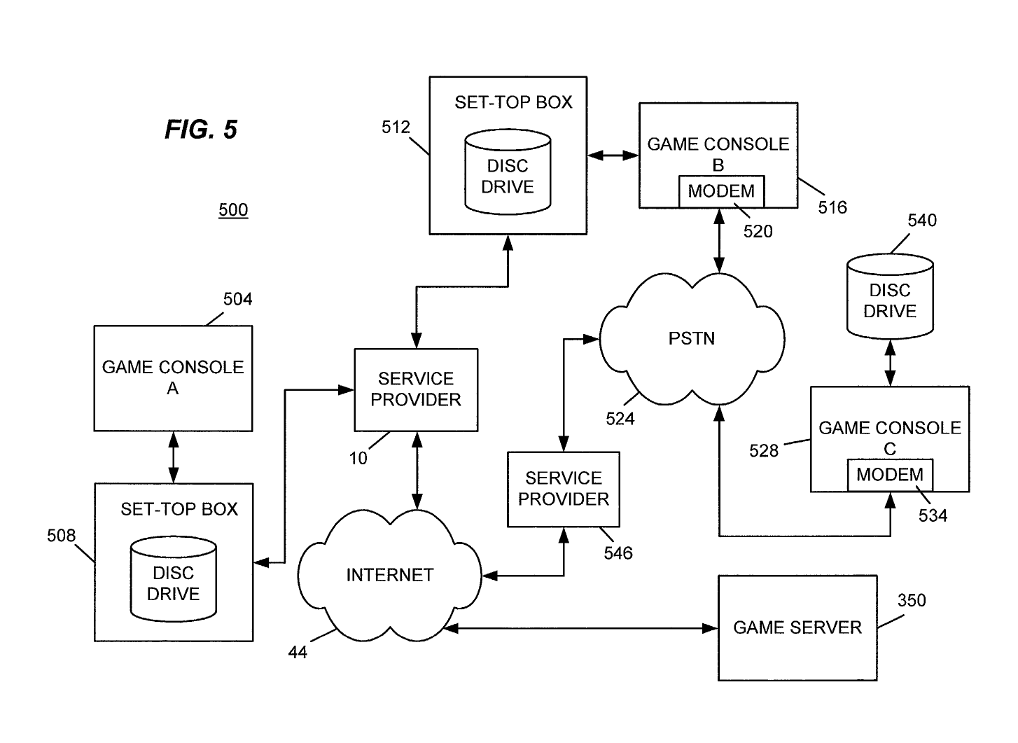

In other embodiments of the present invention, users of Electronic Game Consoles can connect together via the Internet 44, or service provider 10 or directly using a modem connection to exchange game software. An illustrative network of Electronic Game Consoles is illustrated as network 500 of FIG. 5. Network 500 is presented to illustrate the various ways that Electronic Game Consoles can be interconnected, and should not be considered in any way limiting as to the various interconnection arrangements. In this network, a Game Console A (504) is connected to a STB 508 incorporating an associated disc drive. STB 504 is in turn coupled to service provider 10 as previously illustrated. Also previously illustrated, service provider 10 is coupled to the Internet 44 and can thus communicate with the game server 350. The user of Game Console A (504) can thus download game software from game server 350 via the Internet 44 through service provider 10 as previously described.

A second STB 512 is also illustrated as interconnected with service provider 10 and is further coupled to a second Electronic Game Console B (516). This connection permits the two Electronic Game Consoles 504 and 516 to exchange software via their common connection to the service provider 10. Alternatively, the two Electronic Game Consoles 504 and 518 might exchange software by connection to an appropriate Internet site via Internet 44, with the game consoles using the common link of the service provider 10 to facilitate this exchange.

Game Console 518, as illustrated, further includes a modem 520 (e.g., coupled to the internal bus 322 of the Game Console) that permits the Game Console 520 to communicate directly to the Public Switched Telephone System (PSTN) 524 (or any other telephone system). A third Electronic Game Console C (528) also incorporating an internal or externally connected modem 534 can similarly connect to the PSTN 524. Game Console 528 may include a connected disc drive 540 to provide for game storage. Using the ability to connect via the PSTN 524, Game Consoles 516 and 534 can communicate directly with each other, using known communication technology, to facilitate exchange of information and game software directly to be stored on disc drive 540 or the internal disc drive of STB 512.

Since Game Consoles 516 and 528 incorporate modems to permit communication directly with the PSTN 524, each of the Game Consoles 516 and 528 can also be utilized to access an Internet service provider 546 and thus Internet 44. By this connection, these game consoled 516 and 528 can access game server 350 to download software, or alternatively, to communicate with Game Console 504 (or each other) via the Internet 44. Therefore, any number of possible interconnections can be utilized to facilitate receipt of game software for storage on internal or connected disc drives coupled to the Electronic Game Console, whether forming a part of a STB or other home network storage device.

Thus, the user can gain the benefit of existing mass storage present in the STB 22 or PVR (for example) of the home entertainment system to which the Electronic Game Console 304 might normally be attached anyway. This interoperability of the Electronic Game Console 304 with STB 22 and other network storage devices reduces the manufacturing cost and sale price of the Electronic Game Console 304, while providing the user with ready access to mass storage and high speed Internet access for interactive game play and downloading of game software.

Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will also appreciate that the program steps used to implement the embodiments described above can be implemented using disc storage as well as other forms of storage including Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention is preferably implemented using a programmed processor executing programming instructions that are broadly described above in flow chart form and can be stored in any suitable electronic storage medium. However, those skilled in the art will appreciate that the processes described above can be implemented in any number of variations and in many suitable programming languages without departing from the present invention. For example, the order of certain operations carried out can often be varied, and additional operations can be added without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. In an electronic game console, a method of accessing an electronic game, comprising:
determining that a set-top box having a mass storage device is connected to the electronic game console, the mass storage device storing software implementing the electronic game; and
at the electronic game console, accessing the software stored on the mass storage device that implements the electronic game in order to run the electronic game on a central processor situated in the game console.

2. The method according to claim 1, wherein the mass storage device comprises a disc drive.

3. The method according to claim 2, wherein the disc drive comprises a PVR disc drive coupled to the set-top box.

4. The method according to claim 1, further comprising caching elements of the software implementing the electronic game in memory situated within the game console.

5. The method according to claim 1, further comprising storing the software implementing the electronic game on the mass storage device.

6. The method according to claim 1, further comprising downloading the software implementing the electronic game to the mass storage device via the Internet.

7. The method according to claim 1, further comprising selecting the software implementing the electronic game from a menu upon determining that the set-top box is coupled to the electronic game console.

8. An electronic game console, comprising:
a central processor;
memory coupled to the central processor to store data and instructions;
an interface, coupled to the central processor, suitable for connection to a television set-top box; and
program means, residing in the memory, for accessing game software residing on the set-top box.

9. The apparatus according to claim 8, wherein the program means further comprises means for determining if a set-top box is connected to the interface.

10. The apparatus according to claim 8, wherein the program means further comprises means for presenting a user with a menu of games stored as software programs on the set-top box.

11. The apparatus according to claim 8, wherein the interface further comprises means for passing video images for display on a display to the set-top box.

12. The apparatus according to claim 8, wherein the program means further comprises means for caching elements of the game software to the memory.

13. The apparatus according to claim 8, further comprising:
a graphics processor, coupled to the central processor, that generates representations of graphics images; and
a video display interface for passing images from the graphics processor to a video display.

14. The apparatus according to claim 8, further comprising:
a game storage device; and
wherein the program means further comprises means for determining if a set-top box is connected to the interface, and if so for presenting a user with a menu of games stored on the set-top box.

15. The apparatus according to claim 14, wherein the program means further comprises means for accessing a game stored in the game storage device if the set-top box is not connected to the interface.

16. An electronic game system, comprising:
a television set-top box having an associated mass storage device;
a display coupled to the television set-top box for viewing images;
an electronic game console, the game console comprising:
a central processor;
a game storage device coupled to the central processor;
memory coupled to the central processor to store data and instructions;
an interface, coupled to the central processor, suitable for connection to the television set-top box;
means for determining if the television set-top box is connected to the interface and if so, for presenting a user with a menu of games stored as software programs on the set-top box, and if not, for accessing a game stored in the game storage device;
program means, residing in the memory, for accessing game software residing on the mass storage device of the set-top box and for caching elements of the game software to the memory; and
wherein the interface is suitable for passing signals representing video images from the game console to the set-top box and is further suitable for providing the central processor with access to software programs stored on the set-top box's mass storage device.

17. The apparatus according to claim 16, further comprising a graphics processor, coupled to the central processor, that generates representations of graphics images; and
a video display interface for passing images from the graphics processor to a video display.

18. The apparatus according to claim 16, further comprising, a modem forming a part of the set-top box, for downloading the electronic game software via the Internet.

19. A television set-top box, comprising:
a central processor unit;
memory coupled to the central processor unit;
a mass storage device operatively coupled to the central processor unit;
a modem connected to the central processor unit suitable for connecting to the Internet;
a computer program that resides in the memory and permits downloading of a software program implementing an electronic game for storage to the mass storage device from the Internet via the modem; and
an interface suitable for connection to an electronic game console to permit the game console to access the software program implementing the electronic game residing on the mass storage device.

20. The apparatus according to claim 19, further comprising program means, responsive to a message received over the interface, for transferring at least an element of the software program implementing the electronic game from the mass storage device to the electronic game console.

21. The apparatus of claim 19, wherein the interface is selected from one of an RS-232 interface, an Ethernet Interface, an IEEE-1394 interface and a USB interface.

22. A storage media storing instructions which, when executed on a programmed processor residing in a television set-top box, carry out the steps of:
determining that a set-top box having a mass storage device is connected to an electronic game console, the mass storage device storing software implementing an electronic game; and
accessing the software stored on the mass storage device that implements the electronic game in order to run the electronic game on a central processor situated in the game console.

23. The electronic storage medium according to claim 22, wherein the instructions further comprise caching elements of the software implementing the electronic game in memory situated within the game console.

24. The electronic storage medium according to claim 22, wherein the instructions further comprise presenting the software implementing the electronic game on a menu upon determining that the set-top box is coupled to the electronic game console.
